(19) United States
(12) Patent Application Publication
(10) Pub. No.: US 2006/0266712 A1
(43) Pub. Date: Nov. 30, 2006

(54) GROUNDWATER TREATMENT

(76) Inventor: Steven L. Wilhelm, Corvallis, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/420,713

(22) Filed: May 26, 2006

Related U.S. Application Data
(60) Provisional application No. 60/685,169, filed on May 27, 2005.
(60) Provisional application No. 60/797,887, filed on May 5, 2006.

(51) Int. Cl. B09C 1/00

(52) U.S. Cl. 210/747

(57) ABSTRACT

Groundwater treatment systems comprise a fluid displacement mechanism configured to displace an operating fluid along an operating path, a fluid interface configured to introduce a treatment fluid into the operating path, and an outlet configured to expel the operating fluid into an aquifer. Methods of treating groundwater comprise displacing an operating fluid along an operating path, introducing a treatment fluid into the operating path so that the operating fluid carries the treatment fluid, and bringing the treatment fluid into contact with groundwater.

### CROSS-REFERENCE TO RELATED APPLICATIONS

This application is based upon and claims priority under 35 U.S.C. § 119(e) to the following U.S. provisional applications which are incorporated herein by reference in their entireties for all purposes: Ser. No. 60/685,169, entitled “BLOWER-LESS AIR SPARGING USING RE-CIRCULATING WELLS,” filed on May 27, 2005; Ser. No. 60/797,887, entitled “BLOWERLESS AIR SPARGING/DISSOLVED OXYGEN ENHANCEMENT/BLOWERLESS IN-WELL STRIPPING,” filed on May 5, 2006; and Ser. No. ______, entitled “GROUNDWATER TREATMENT SYSTEMS,” filed on May 20, 2006.

### BACKGROUND

Groundwater is frequently contaminated with contaminants of human origin or natural origin. A need thus arises for treating groundwater by reducing or removing contaminants, such as by physically removing contaminants, chemically altering contaminants, and/or initiating or promoting biological modification or degradation of contaminants.

Some groundwater treatment methods involve removal of the groundwater from the aquifer for treatment, either with or without returning the water to the aquifer after treatment. Other methods do not involve removal of the groundwater from the aquifer, and are referred to as in situ methods.

Groundwater treatment methods also may involve the use of consumables, such as chemical reagents, biological nutrients, adsorptive or reactive treatment media, compounds that release chemical reagents such as oxygen or hydrogen, and many other consumable substances that have to be replenished as the treatment process progresses.

Air sparging is one method of groundwater treatment that may be used in situations where the contaminants are volatile (i.e., the contaminants may be easily removed simply by coming into contact with air or another gas). Air sparging may involve blowing pressurized air into a well using a blower or compressor, and forcing the air into, and allowing the air to percolate through, the aquifer. If and when the released air comes into contact with groundwater, contaminants from the water may partition (or be stripped) into the air, and thus be removed from the groundwater when the air eventually migrates above the water table.

In addition to stripping the groundwater of contaminants, air sparging also potentially involves aeration of the groundwater. Groundwater is often oxygen-depleted due to natural biological processes. Thus, when air comes into contact with the oxygen-depleted groundwater, oxygen from the air may dissolve in the groundwater. The dissolved oxygen may then aid in biodegradation of some contaminants.

As mentioned, air sparging may involve the use of a blower or compressor to provide the adequate pressure required to force the air down a well and into an aquifer. A blower or compressor, however, may require placement above ground, and may be a source of unwanted noise, security issues, and aesthetic issues, to name just a few. In addition, the process of compressing the air for insertion into the aquifer requires a considerable amount of costly energy, and may produce wasted heat that generally requires management so as not to adversely affect the surrounding environment.

### BRIEF DESCRIPTION OF THE DRAWINGS

FIG. 1 is a schematic diagram showing fluid flow in accordance with an exemplary system for treating groundwater.

FIG. 2 is another schematic diagram showing fluid flow in accordance with another system for treating groundwater.

FIG. 3 is a flow chart illustrating exemplary methods of treating groundwater.

FIG. 4 is a schematic illustration of an exemplary groundwater treatment system.

FIG. 5 is an illustration of an exemplary fluid interface.

FIG. 6 is an illustration of another exemplary fluid interface.

FIG. 7 is a cross-sectional view illustrating exemplary groundwater treatment systems.

### DETAILED DESCRIPTION

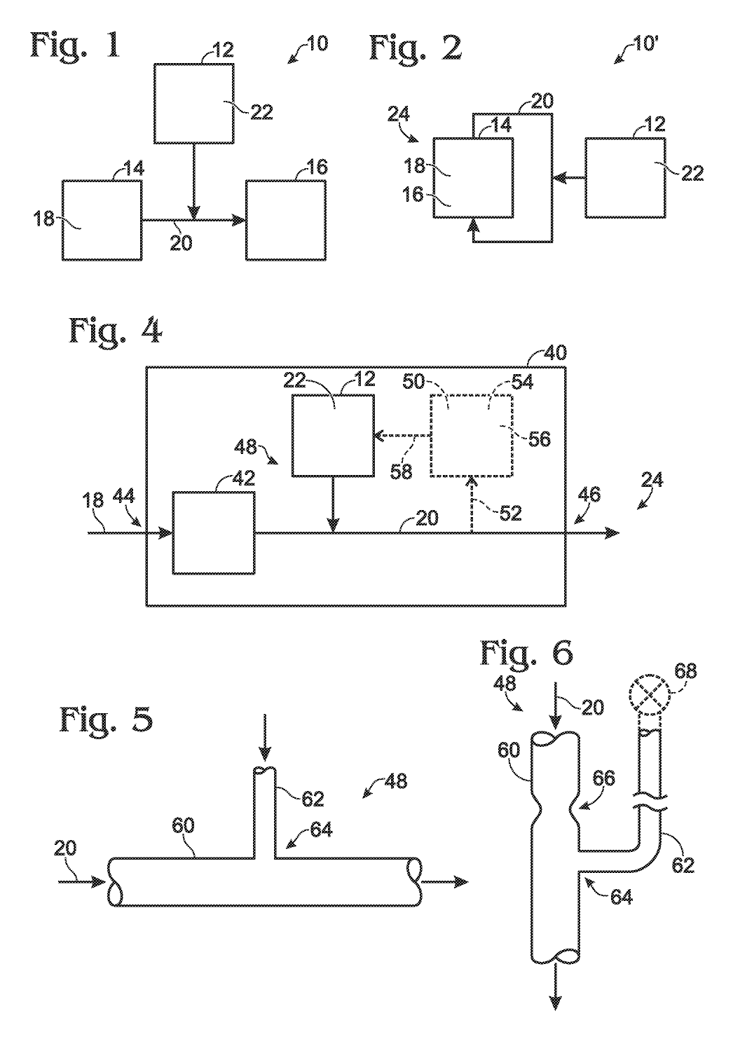

FIG. 1 depicts a schematic diagram 10 showing fluid flow in an exemplary groundwater treatment system. As indicated, the system involves a treatment fluid source 12, an operating fluid source 14, and groundwater 16.

In operation, the groundwater treatment system displaces an operating fluid 18 (from operating fluid source 14) along an operating path 20, and introduces a treatment fluid 22 (from treatment fluid source 12) into the operating path. The operating fluid thus may be employed to carry the treatment fluid, and to bring the treatment fluid into contact with groundwater.

Treatment fluid 22 may be any fluid (gas or liquid) that is suitable for treating contaminated groundwater. Non-limiting examples of such treatment fluids include air, oxygen, nitrogen, hydrogen, argon, ozone, etc., either in gaseous or liquid form. Various combinations of the above treatment fluids, and other treatment fluids, also are within the scope of the present disclosure.

Treatment fluid source 12 may take a variety of forms. For example, where the treatment fluid is air, source 12 may be the ambient atmosphere. Additionally or alternatively, treatment fluid source 12 may be a pressure vessel or other appropriate container that is configured to contain and provide a treatment fluid for introduction into operating path 20, with or without assistance.

Operating fluid 18 may be any fluid (gas or liquid) suitable for use in carrying a fluid such as treatment fluid 22 along operating path 20. In other words, when operating fluid 18 is displaced, or otherwise moved, from one location to another, the operating fluid should be capable of carrying or displacing treatment fluid that may be introduced into the path of the operating fluid. A non-limiting example of such an operating fluid is water, but other fluids are within the scope of the present disclosure.

Operating fluid source 14 may take any of a variety of forms. For example, where the operating fluid is water, operating fluid source 14 may be an aquifer, a water main, a water tower, etc. The present disclosure is not limited to the operating fluid being water from an aquifer. Furthermore, when the operating fluid is water, it may be clean water from a source other than an aquifer.

Turning now to FIG. 2, a schematic diagram 10′ is provided, showing fluid flow in another exemplary groundwater treatment system. In schematic diagram 10′, the system will again be seen to involve treatment fluid source 12, operating fluid source 14, and groundwater 16. However, in schematic diagram 10′, operating fluid 18 is groundwater 16. Furthermore, the operating fluid source 14 takes the form of an aquifer 24.

Accordingly, treating groundwater may involve displacing groundwater 16 from aquifer 24 along operating path 20, introducing treatment fluid 22 from treatment fluid source 12 into operating path 20 such that the treatment fluid may be carried downstream by groundwater 16, mixing the treatment fluid with the groundwater to produce treated groundwater, and expelling the treated groundwater into aquifer 24.

As used herein, treated groundwater refers to the mixture of groundwater and treatment fluid once treatment fluid is introduced into the operating path. The flow of treated groundwater downstream is defined by the direction of flow toward expulsion into the aquifer. It is noted, however, that the entire amount of treatment fluid introduced into the operating path may or may not be expelled into the aquifer. A more detailed explanation of fluid flow into the aquifer is provided below.

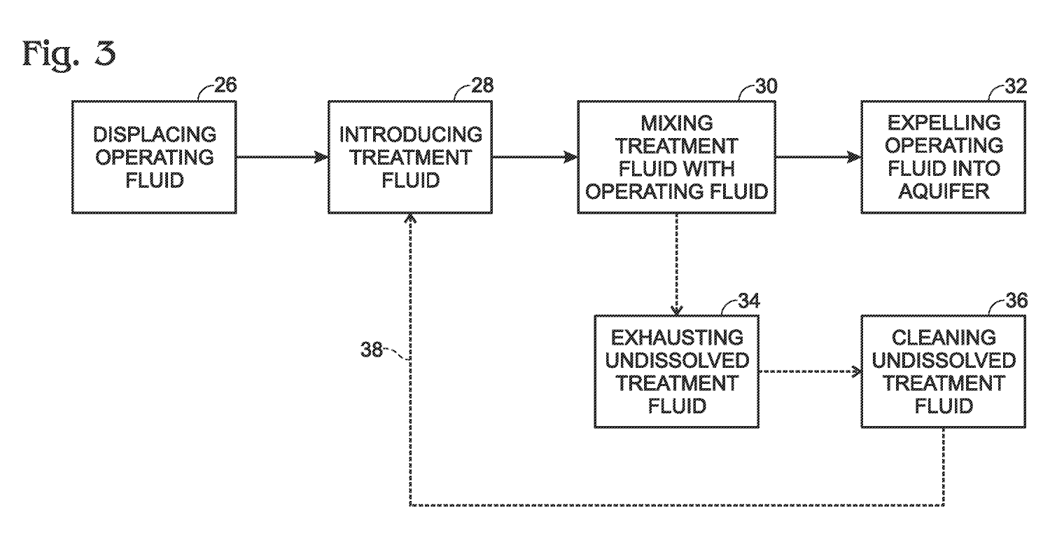

FIG. 3 is a flow chart illustrating various methods of groundwater treatment. As indicated, such methods may include: displacing an operating fluid along an operating path, as indicated at 26; introducing a treatment fluid into the operating path, as indicated at 28; mixing the treatment fluid with operating fluid, as indicated at 30; and expelling the treated operating fluid into an aquifer, as indicated at 32. As will be explained further below, the treated operating fluid may or may not include the treatment fluid (which may be exhausted prior to introduction of the operating fluid into the aquifer).

In some instances, mixing the treatment fluid with the operating fluid may involve at least partially dissolving the treatment fluid in the operating fluid. Where the operating fluid is groundwater, it may be desirable to use air as the treatment fluid (or another fluid that has oxygen as a constituent thereof) because the dissolution of oxygen into groundwater may be beneficial in the treatment of the groundwater under some circumstances. It will be appreciated, for example, that some groundwater contaminants are aerobically biodegradable (i.e., they naturally degrade when in contact with oxygen).

In some instances, displaced groundwater may be oxygenated to full saturation of the groundwater and even over-saturation of the groundwater (where the groundwater and treatment fluid mixture are under pressures greater than one atmosphere). As such, groundwater treatment may involve compressing the treatment fluid and operating fluid to accommodate dissolution of the treatment fluid into the operating fluid. Furthermore, in systems where operating path 20 has a vertical component (i.e., is not entirely horizontal) downstream from where the treatment fluid is introduced into the path, gravity may assist with the compression of the operating fluid.

Oxygenation of water, even to the point of saturation, requires relatively little air compared to the amount of air required for other forms of groundwater treatment. For example, at one atmosphere, full saturation of water with oxygen is a concentration of ten and one half parts per million. Accordingly, if the dissolved oxygen level in groundwater is initially zero, a ratio of only one to twenty-five (by volume) of air to water is required to fully oxygenate the water.

Methods of treating groundwater that include dissolution of oxygen may be referred to as employing dissolved oxygen enhancement. However, dissolution of substances other than oxygen also may be beneficial in the treatment of contaminated groundwater, and thus are also within the scope of the present disclosure. Accordingly, as used herein dissolved oxygen enhancement shall be construed as referring to methods involving dissolution of treatment fluids including both oxygen and substances other than oxygen.

As will be appreciated, the treatment fluid may be employed to at least partially strip contamination from the operating fluid. This stripping may be particularly useful where the operating fluid is contaminated groundwater. In such a setting, the treatment fluid may be mixed (or otherwise brought into contact with) the groundwater. Contaminants in the groundwater, in turn, may be partitioned from the groundwater (naturally, without further intervention), and may be entrained in treatment fluid. As a result, contamination may be removed from the groundwater by exhausting the affected treatment fluid.

Stripping of contaminated groundwater may occur within a well, in another portion of the groundwater treatment system, or in the aquifer itself. Where stripping occurs within the well, the system may be referred to as an in-well stripping system. Where stripping occurs in the aquifer, the system may be referred to as a sparging system.

Some groundwater treatment may involve both dissolved oxygen enhancement and stripping. Such methods may be achieved by introducing more treatment fluid than may be dissolved into the groundwater upon mixing. Variables impacting the amount of treatment fluid needed to reach saturation include (but are not limited to) the degree of agitation (or mixture) of the groundwater and the treatment fluid, the length of time of mixture, pressure, etc. For example, where air is being used as a treatment fluid, a portion of the air may dissolve in the groundwater (e.g., the nitrogen and oxygen in the air), while the remaining portions (e.g., excess nitrogen and oxygen) of the air may remain undissolved, functionally and effectively stripping contaminants from the groundwater. These systems may be implemented either in in-well stripping or sparging systems, as discussed above.

As noted, some systems may exhaust treatment fluid not dissolved in the operating fluid (i.e., undissolved treatment fluid), as indicated at 34 in FIG. 3. This may prevent stripped contaminants from being expelled into an aquifer. Accordingly, contaminated treatment fluid may be removed from the mixture of operating fluid and treatment fluid (also referred to herein as the “treated operating fluid” or the “treated groundwater”) prior to the operating fluid being expelled into the aquifer. This may reduce the risk of contaminants stripped from groundwater (i.e., the operating fluid) leaching back into the groundwater, as would occur, for example, where undissolved treatment fluid is expelled into an aquifer (e.g., sparging).

Depending on the nature of the treatment fluid and contaminant (or contaminants) removed from the operating fluid, the contaminated treatment fluid may be stored, treated, or released directly into the ambient environment. Where the contaminant would be detrimental to the environment if simply vented to the atmosphere, the system may clean the exhausted treatment fluid, as indicated in FIG. 3 at 36. Stated differently, the system may be configured to remove contaminants from the undissolved treatment fluid to create a cleaned treatment fluid. It will be appreciated that treatment fluid may be cleaned of contaminants whether or not contaminants would be harmful to the environment.

The cleaned treatment fluid also may be recycled by re-introducing such treatment fluid into the operating fluid path, as indicated at 38. This may be accomplished by delivering cleaned treatment fluid to a source of treatment fluid for later use. The cleaned treatment fluid thus may be reintroduced into the operating fluid, remixed with operating fluid, and again exhausted from the treated operating fluid. Thereafter, the exhausted treatment fluid may again be cleaned of contaminants, and re-introduced to untreated operating fluid yet again.

Turning now to FIG. 4, a groundwater treatment system 40 is schematically illustrated, system 40 being configured to implement the methods discussed above. System 40 thus includes a fluid displacement mechanism 42, which drives operating fluid 18 along an operating path 20. Operating fluid is received via an inlet 44, is treated, and ultimately passes to an outlet 46. A fluid interface 48 is configured to introduce treatment fluid 22 into the operating path, the treatment fluid being from a treatment fluid source 12 that may or may not form a part of groundwater treatment system 40.

As illustrated, outlet 46 may be configured to expel the treated operating fluid into aquifer 24. In some systems (e.g., in-well stripping systems), the treated operating fluid may be expelled with only minimal treatment fluid (dissolved or undissolved). In other systems (e.g., sparging systems), the treated operating fluid may be expelled with undissolved treatment fluid. In still other systems (e.g., dissolved oxygen enhancement systems), the treated operating fluid may be expelled as operating fluid with dissolved treatment fluid, and with little or no undissolved treatment fluid.

Groundwater treatment system 40 may employ an exhaust device 50 configured to provide an exhaust path 52 for undissolved treatment fluid. Exhaust device 50 thus will be understood to provide an alternative to expelling undissolved treatment fluid into aquifer 24. Exhaust device 50 may be any suitable mechanism for exhausting undissolved treatment fluid. As a non-limiting example, it will be appreciated that the exhaust device may include a conduit or pipe that provides an exhaust path for undissolved treatment fluid.

Groundwater treatment system 40 may employ a cleaning device 54 to remove contamination from the undissolved treatment fluid. The cleaning device may include any suitable mechanism for generally removing contaminants from the contaminated treatment fluid including (but not limited to) a filter such as an adsorptive medium (e.g., granular activated carbon), or any other mechanism configured to remove contaminants from a supply of contaminated fluid.

A recycling device 56 also may be employed, the recycling device being configured to return cleaned undissolved treatment fluid to the source of treatment fluid, as generally indicated at 58. Recycling device 56 may include any suitable mechanism or componentry for delivering cleaned undissolved treatment fluid to its source. For example, recycling device 56 may simply be a conduit or pipe functionally connecting cleaning device 54 with treatment fluid source 12.

As indicated above, fluid displacement mechanism 42 is configured to drive the operating fluid along operating path 20. As such, fluid displacement mechanism 42 may take the form of a positive displacement pump, a dynamic pump, or any other mechanism configured to generally move, or displace, a fluid from one location to another. Fluid displacement mechanism 42 may be incorporated at any suitable point along path 20 such that it may functionally direct operating fluid from the inlet to the outlet.

Fluid interface 48 introduces treatment fluid from treatment fluid source 12 into operating fluid path 20. Upon such introduction, a mixture of operating fluid and treatment fluid is produced. This mixture of operating fluid and treatment fluid is sometimes referred to herein as treated operating fluid. Fluid interface 48 may include any number of mechanisms and/or components that generally permit introduction of a treatment fluid into the path of operating fluid.

As will be appreciated, fluid interface 48 may be configured to create a pressure differential between at least a portion of operating path 20 and treatment fluid source 12 so as to draw treatment fluid 22 into operating path 20. The operating fluid may then carry the treatment fluid along the operating path. In other words, fluid interface 48 may be configured to introduce the treatment fluid into the operating path without the need for a mechanism such as a treatment fluid pump, compressor, or blower. Fluid interface 48 may provide a mechanism for introducing the treatment fluid into the path of operating fluid in response to the movement of the operating fluid itself.

Turning to FIG. 5, a non-limiting example of fluid interface 48 is illustrated, the fluid interface including a portion of an operating fluid conduit 60 and a portion of a treatment fluid conduit 62. The conduits intersect such that treatment fluid conduit 62 may introduce treatment fluid into the operating path at a junction 64. As the operating fluid is moved through the operating fluid conduit, the treatment fluid is drawn into the operating path (as indicated by the arrow) when the pressure of the operating fluid at junction 64 is less than the pressure of the treatment fluid source. Conversely, the treatment fluid is not drawn into the operating path when the pressure of the operating fluid at junction 64 is greater than the pressure of the treatment fluid source.

A number of variables may affect the pressure of the operating fluid in the operating fluid conduit including (but not limited to) the power of the fluid displacement mechanism, the cross-sectional area of the operating fluid conduit, the velocity of the operating fluid, and the orientation of the operating fluid conduit, among others. The pressure of the treatment fluid source similarly may be affected by a number of variables. Additionally or alternatively, if the treatment fluid is air and the source of the air is the ambient atmosphere, the ambient atmosphere pressure may provide all of the force required for introduction of treatment fluid into the operating path.

The effective pressure of the treatment fluid source may be varied to increase or decrease the rate of treatment fluid introduction into the path of the operating fluid. For example, as mentioned above, the source of the treatment fluid may include a supply of treatment fluid pressurized in a pressure vessel. Additionally or alternatively, a blower, compressor, or pumping device may be provided to effectively increase the pressure of the treatment fluid source, and thereby, to assist in the introduction of treatment fluid into the operating path.

These and other variables may all be manipulated by a system designer in order to provide a fluid interface appropriate for a particular application. For example, a designer may take into account factors such as the depth of the static groundwater level, the particular contaminant being removed from the groundwater, and the degree of contamination when designing a groundwater treatment system according to the present disclosure.

Turning now to FIG. 6, three supplemental fluid interface features are illustrated, each of which may affect the introduction of the treatment fluid into operating path 20 and/or the mixing of the treatment fluid with the operating fluid.

First, a flow restrictor 66 has been added to operating fluid conduit 60, upstream from junction 64. As the operating fluid is displaced through the operating fluid conduit, the operating fluid may be jetted through flow restrictor 66. When this occurs, a partial vacuum is created downstream of flow restrictor 66 and a siphoning effect is produced to draw treatment fluid into operating fluid conduit 60. This arrangement may be referred to as a venturi configuration. For example, aspirators, jet pumps, ejectors, and eductors are all forms of venturi configurations that may be used to describe at least a portion of the fluid interface described herein. Additionally or alternatively, a venturi product (as is commonly available for use in various fluid flow applications, including (but not limited to) aspirators, jet pumps, ejectors, and eductors) may simply be incorporated into the operating fluid conduit at junction 64. Exemplary venturi products are found in the Penberthy line of jet pumps manufactured by TYCO® FLOW CONTROL™.

FIG. 6 also demonstrates that the orientation of operating fluid conduit 60 may be such that at least a portion of the operating fluid conduit (and thus a portion of path 20) is generally vertical (or upright). Though illustrated as generally vertical, it will be appreciated that an operating fluid conduit 60 with any vertical component (i.e., any deviation from horizontal), is suitable to provide for assistance of gravity in the displacement of the operating fluid along operating path 20. Therefore, as gravity acts on the flow of the operating fluid, and the operating fluid is pulled down and away from junction 64, a partial vacuum and siphoning effect is increased. Gravity thus aids in the drawing of treatment fluid into operating fluid conduit 60.

In systems where the operating fluid is groundwater, the non-horizontal orientation of operating fluid conduit 60 may additionally aid in the aeration, or oxygenation, of the operating fluid. As mentioned above, oxygenation of contaminated groundwater may be beneficial in circumstances where the contaminants are aerobically biodegradable. As the groundwater and treatment fluid mixture are displaced in a downward direction, the overall effective pressure of the mixture rises due to the column, or head, of the mixture. As this pressure increases, the treatment fluid may increasingly dissolve in the operating fluid. As discussed above, this may enable an effective saturation of the operating fluid with treatment fluid greater than would be otherwise possible at atmospheric pressure. Stated differently, in systems where at least a portion of the path has a vertical component downstream from where the treatment fluid is introduced into the operating path, gravity may assist with the compression of the operating fluid, and the dissolution of the treatment fluid into the operating fluid.

In addition to varying the pressure of the source of treatment fluid, the rate of introduction of the treatment fluid may be manipulated by varying the flow of treatment fluid within the treatment fluid conduit. Treatment fluid conduit 62 thus may be provided with a valve 68, or other flow regulating device. Such flow regulating device may take the form of an orifice with an opening smaller than the cross-sectional area of the treatment fluid conduit. Alternatively, flow regulating device 68 may be a spring-operated poppet valve, such as a vacuum breaker valve, which would serve to admit air, or other treatment fluid, under controlled conditions. Flow regulating device 68 may be a user-adjustable valve, such that the rate of introduction of treatment fluid may be varied at different instances. Additionally or alternatively, flow regulating device 68 may incorporate a pressure or vacuum regulator, which would regulate the flow of treatment fluid.

Where the treatment fluid is a gas, a diffuser may be incorporated into fluid interface 48 at or near junction 64 such that the treatment fluid is diffused into small or micro-bubbles as it is introduced to the operating fluid. As used herein, the term diffuser refers to mechanisms or devices configured to diffuse a gas into bubbles within a liquid.

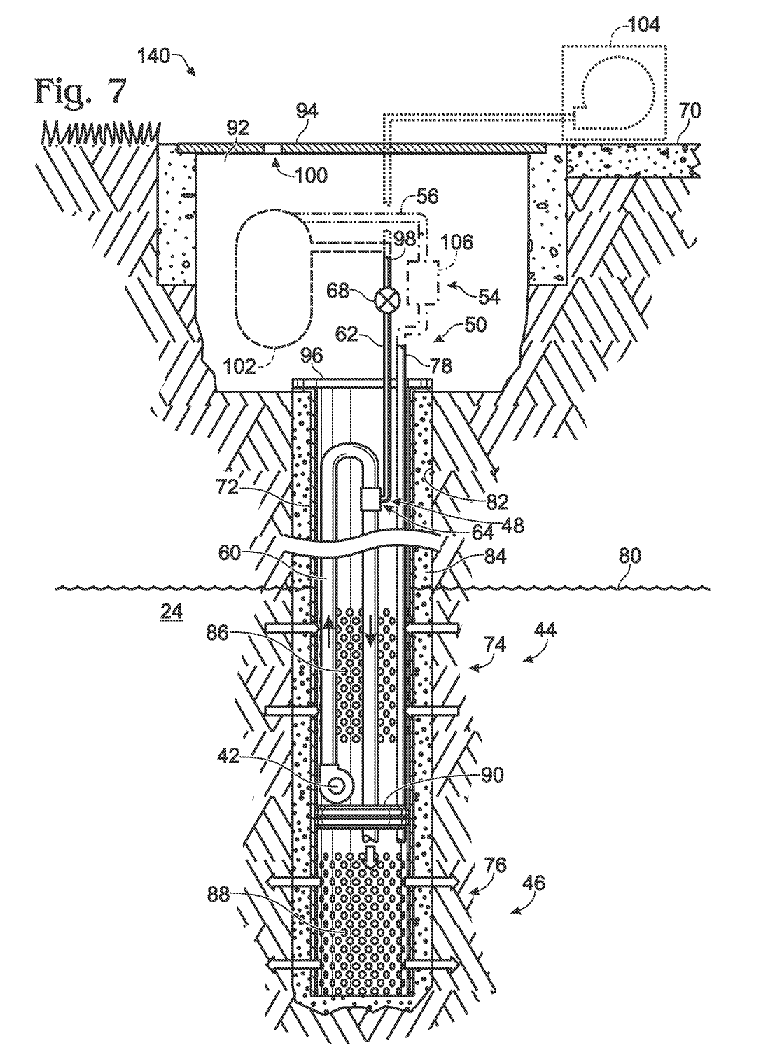

A more detailed description of a groundwater treatment system is now provided with reference to FIG. 7. As indicated, FIG. 7 shows a groundwater treatment system at 140, such system being configured for subterranean installation (e.g., below ground level 70). Groundwater treatment system 140 may be configured so that the operating fluid is groundwater from an aquifer 24. The system may include a well-casing 72 having an inlet portion 74 (defining inlet 44), an outlet portion 76 (defining outlet 46), a fluid displacement mechanism 42 (possibly in the form of a pump), a fluid interface 48, an operating fluid conduit 60, a treatment fluid conduit 62 (including a valve 68), and an exhaust conduit 78. Well-casing 72 may be installed so that inlet and outlet portions 74, 76 are located generally below a static groundwater level 80

Well-casing 72 may be a generally cylindrical well-casing made of PVC, or other appropriate material, placed into an appropriately sized borehole 82 formed below ground level 70. Borehole 82 and well-casing 72 may be sized appropriately for various applications of groundwater treatment systems according to the present disclosure. For example, variables such as groundwater depth, aquifer thickness, characteristics of ground material, and other factors may dictate the suitable diameter and depth of the borehole and well-casing and/or wall-thickness of the well-casing. Additionally, borehole 82 may be sized larger than well-casing 72 in order to include a circumferential layer of media 84, which may provide additional filtering of groundwater as it enters the system at inlet 44.

Well-casing 72 includes an inlet screen 86 and an outlet screen 88 separated by a seal mechanism (or packer) 90. Screens 86, 88 may be configured to generally prevent debris from entering the well-casing, yet still allow groundwater to pass through. The screens may be perforations or slots of various sizes depending on the configuration of groundwater treatment system. For example, variables including (but not limited to) the type of liquid displacement mechanism (or pump) being used, the degree of filtration required or desired, the incorporation of a layer of media 84, and the characteristics of the ground in the general vicinity of the groundwater treatment system, may all dictate how large or small the perforations or slots of the screens may be for a particular system.

As mentioned, inlet and outlet screens 86, 88 may be separated by packer 90, thereby effectively defining inlet portion 74 and outlet portion 76. Packer 90 may effectively provide a seal between the inlet and outlet portions and thus generally prevent groundwater from migrating directly (not via operating fluid conduit 60) from the inlet portion to the outlet portion, or vise versa.

Though illustrated as having the inlet portion above the outlet portion, it will be understood that the groundwater treatment system may be configured with the inlet portion below the outlet portion. Also, though depicted as being fully below static groundwater level 80, inlet and outlet portions 74, 76 need not necessarily be fully below the groundwater level. For example, as long as inlet portion 74 is at least partially below the static groundwater level, groundwater can be effectively drawn into the system. Also, outlet portion 76 may be located above the static groundwater level. In such configurations, treated groundwater would simply be expelled from outlet 44 and migrate back down to the aquifer due to gravity.

Well-casing 72 may be installed below ground level 70, such that a man-hole region 92 may be provided to enable access to various components of the system. As illustrated, the system may include a man-hole cover 94 configured for selective removal enabling such access. In addition, well-casing 72 may be capped or otherwise separated from manhole region 92 by a cap 96. The cap may be configured for selective removal by a user for periodic maintenance or other access to various components of system 140.

Fluid displacement mechanism 42 is illustrated below inlet screen 86 and above packer 90, but other configurations are possible. For example, the fluid displacement mechanism may be located generally toward the top of well-casing 72 or even within manhole region 92 so that the mechanism may be easily serviced if necessary after initial installation of a system 140. However, location of mechanism 42 in the illustrated location (below the inlet screen and thus below groundwater level 80) may provide for convenient initial installation of groundwater treatment systems due to the avoidance of having to prime the fluid displacement mechanism.

Operating fluid conduit 60 may extend from fluid interface 48 generally upwardly towards cap 96, make a turn, and extend back downwardly through the well casing, through packer 90, and into (or just above) outlet portion 76. As such, operating fluid conduit 60 is configured to generally provide a path for groundwater to be displaced by fluid displacement mechanism 42 from inlet portion 74 to outlet portion 76.

Operating fluid conduit 60 may be any suitable conduit appropriately sized for a particular installation and application of the groundwater treatment system. For example, conduit 60 may be generally circular in cross-section and be made of PVC or other suitable material. Operating fluid conduit 60 is illustrated as terminating just below the packer but above the outlet screen. This configuration, though not required, may be beneficial for embodiments where undissolved treatment fluid is exhausted via exhaust conduit 78.

Treatment fluid conduit 62 may extend from manhole region 92 (or from above ground) to a junction 64, where the treatment fluid conduit and operating fluid conduit intersect. In FIG. 7, this junction is downstream of the bend in the operating fluid conduit. Other configurations, however, are also suitable to draw treatment fluid into the operating path in response to a pressure-differential, as discussed above. Like operating fluid conduit 60, treatment fluid conduit 62 may be any suitable conduit appropriately sized for a particular installation and application of the system. For example, treatment fluid conduit 62 may be generally circular in cross-section and be made of PVC or other suitable material.

Treatment fluid conduit 62 may open to the atmosphere within manhole region 92, as indicated at 98. Such configuration is particularly suitable where the treatment fluid is air and the treatment fluid source is the atmosphere. Accordingly manhole cover 94 may include a passage 100 functionally allowing air to enter manhole region 92.

Additionally, treatment fluid conduit 62 may (but need not necessarily) include a flow control mechanism 68 configured to effectively limit or control the amount of treatment fluid introduced into the operating path. As discussed above, such flow control mechanism may simply be an orifice with an opening smaller than the cross-sectional area of the treatment fluid conduit. Alternatively, the flow control mechanism may be a user-adjustable valve or a spring-operated poppet valve, such as a vacuum breaker valve, which would serve to admit air, or other treatment fluid, under controlled conditions.

Fluid interface 48 may include a portion of the operating fluid conduit, a portion of the treatment fluid conduit, and the junction between the two.

Additionally or alternatively, as discussed above, and indicated in dashed lines, treatment fluid conduit 62 may be connected to a treatment fluid source other than the atmosphere. For example, the source may include a pressure vessel 102 configured to provide pressurized treatment fluid such as (but not limited to) air, oxygen, hydrogen, nitrogen, ozone, or any other appropriate treatment fluid, whether in liquid or gas form.

Additionally or alternatively, as indicated in dotted lines, treatment fluid conduit 62 may be attached to a blower, compressor, or any other suitable mechanism 104, for generally providing treatment fluid at a pressure greater than one atmosphere and thus functionally aiding in the introduction of the treatment fluid into the operating fluid conduit. Though illustrated as being installed outside of manhole region 92, mechanism 104 may also be housed within man-hole region 92.

Exhaust conduit 78 may extend from, or just above, outlet portion 76 vertically through packer 90, through cap 96, and into manhole region 92. The exhaust conduit may be configured to prevent at least a portion of any undissolved treatment fluid from being expelled with the treated operating fluid (e.g., groundwater from outlet portion 76). In other words, exhaust conduit 78 may provide a path for any treatment fluid that did not dissolve during mixture with the operating fluid in the operating fluid conduit, such that the undissolved treatment fluid may be brought to, near, or at least toward ground level, and in some embodiments processed for either exhaustion to the atmosphere or reintroduction into the system. Exhaust conduit 78 may be described as forming at least a portion of exhaust device 50.

In operation, treatment fluid will be drawn into operating fluid conduit 60. As the treatment fluid mixes with the operating fluid (e.g., groundwater) and is displaced toward outlet portion 76 of well-casing 72, portions of the treatment fluid may dissolve in the groundwater. Portions of the treatment fluid that do not dissolve in the groundwater (i.e., undissolved treatment fluid) may effectively strip contaminants from the groundwater. When the mixture of groundwater and treatment fluid exits the operating fluid conduit 60, the undissolved treatment fluid may collect below packer 90 and subsequently travel up exhaust conduit 78. As mentioned, this may be beneficial in order to prevent any stripped contaminants from entering aquifer 24 and leaching back into the groundwater.

As noted previously, exhaust conduit 78 may simply be open to the atmosphere, as generally indicated in solid lines. Such a configuration may be employed in situations where the contaminants being removed from the groundwater would not detrimentally impact the environment.

Additionally or alternatively, exhaust conduit 78 may be effectively disabled by capping, or otherwise closing off the conduit opening. In other words, to configure the system for sparging applications (e.g., where it may be desirable to expel any undissolved treatment fluid into aquifer 24), closing off exhaust conduit 78 may direct any undissolved treatment fluid through outlet 44 and into aquifer 24.

In systems employing an exhaust device, the groundwater treatment system may further include a cleaning system 54, as indicated in dash-dot lines. Cleaning system 54 may be configured to remove at least a portion of any contamination from any undissolved treatment fluid that is passed through the exhaust system, in order to prevent discharging these contaminants back into the environment. As mentioned above, cleaning system 54 may include a filter 106, such as an adsorptive medium. The cleaned treatment fluid may then be discharged into the environment, or alternatively as indicated by dash-dot-dot lines, may be recycled via recycling system 56, and be reintroduced into the system for further treatment of the groundwater. As such, the cleaned treatment fluid may comprise at least a portion of the source of treatment fluid.

Though illustrated as being generally below ground level 70, it should be appreciated that various components of groundwater treatment systems according to the present disclosure, including (but not limited to) the operating fluid conduit, the treatment fluid conduit, and the fluid interface, may at least partially be installed above ground level. Additionally, further treatment of the groundwater, whether above or below ground level, may take place in addition to the treatment described herein.

Again describing operation of the depicted system, fluid displacement mechanism 42 draws groundwater from aquifer 24 into inlet portion 74 of well-casing 72 and displaces the groundwater through operating fluid conduit 60. As the groundwater is displaced through the operating fluid conduit, treatment fluid is drawn into, is mixed with, and is carried by the operating fluid toward outlet portion 76. During this process, the treatment fluid may dissolve into and/or strip contaminants from the groundwater. Upon exiting the operating fluid conduit below packer 90, at least the groundwater is expelled out outlet portion 76 and into aquifer 24. In sparging applications (i.e., systems 140 either not including exhaust conduit 78, or systems 140 with exhaust conduit 78 capped or otherwise closed off effectively removing it from the system), any undissolved treatment fluid is expelled from the outlet portion along with the groundwater. In applications where expulsion of any undissolved treatment fluid is not desired, the incorporation of exhaust conduit 78 permits removal of at least a portion of any undissolved treatment fluid from outlet portion 76 without it being expelled into aquifer 24.

Methods of installing groundwater treatment systems are also within the scope of the present disclosure and may comprise: forming borehole 72 from ground level 70 to below groundwater level 80; installing well-casing 72 into the borehole; installing fluid displacement mechanism 42; and installing fluid interface 48.

It is believed that the disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include incorporation of one or more such elements or steps, neither requiring nor excluding two or more such elements or steps.

Inventions embodied in various combinations and subcombinations of features, functions, elements, properties, steps and/or methods may be claimed through presentation of new claims in a related application. Such new claims, whether they are directed to a different invention or directed to the same invention, whether different, broader, narrower, or equal in scope to the original claims, are also regarded as included within the subject matter of the present disclosure.

I claim:

1. A groundwater treatment system, comprising:
a fluid displacement mechanism configured to displace an operating fluid along an operating path;
a fluid interface configured to introduce a treatment fluid into the operating path of the operating fluid; and
an outlet configured to expel the operating fluid into an aquifer.

2. The system of claim 1, wherein the treatment fluid is air.

3. The system of claim 1, wherein the operating fluid is groundwater from the aquifer.

4. The system of claim 1, wherein the fluid interface mixes the treatment fluid with the operating fluid to create treated operating fluid.

5. The system of claim 1, wherein the fluid interface is configured to create a pressure differential between at least a portion of the operating path and a treatment fluid source, thereby drawing the treatment fluid into the operating path.

6. The system of claim 1, wherein the fluid interface is further configured such that gravity assists in introducing the treatment fluid into the operating path and displacing the treatment fluid toward the outlet.

7. The system of claim 1, wherein the operating fluid carries the treatment fluid toward the outlet.

8. The system of claim 1, further comprising:
an operating fluid conduit having a flow restrictor, the operating fluid conduit at least partially defining the operating path; and
a treatment fluid conduit configured to deliver the treatment fluid from a source to a junction with the operating fluid conduit downstream of the flow restrictor.

9. The system of claim 1, wherein the fluid interface further includes a flow control mechanism configured to control the amount of treatment fluid introduced into the operating path.

10. The system of claim 1, wherein the treatment fluid is a gas or mixture of gases and the fluid interface includes a pump configured to assist the introduction of the treatment fluid into the operating path.

11. The system of claim 1, wherein the fluid interface includes a diffuser configured to produce bubbles of treatment fluid upon introducing the treatment fluid into the operating path.

12. The system of claim 1, wherein the fluid interface includes a jet pump.

13. The system of claim 1, wherein the fluid interface includes an aspirator.

14. The system of claim 1, further comprising:
an exhaust device configured to provide an exhaust path for undissolved treatment fluid so that at least a portion of undissolved treatment fluid is not expelled into the aquifer.

15. The system of claim 14, further comprising:
a cleaning device configured to remove at least a portion of any contamination from the undissolved treatment fluid.

16. The system of claim 15, further comprising:
a recycling device configured to deliver at least a portion of any cleaned undissolved treatment fluid to the fluid interface.

17. The system of claim 1, wherein the fluid displacement mechanism and the fluid interface are configured for subterranean installation.

18. A method of treating groundwater, comprising:
displacing an operating fluid along an operating path;
introducing a treatment fluid into the operating path so that the operating fluid carries the treatment fluid; and
bringing the treatment fluid into contact with groundwater.

19. The method of claim 18, wherein the operating fluid is groundwater from an aquifer, wherein introducing includes mixing the treatment fluid with the operating fluid to create treated operating fluid, and wherein the method further comprises expelling the treated operating fluid into the aquifer.

20. The method of claim 19, wherein the treatment fluid is at least partially dissolved in the operating fluid upon mixing the treatment fluid with the operating fluid.

21. The method of claim 20, wherein the treatment fluid is air.

22. The method of claim 20, wherein the treatment fluid includes oxygen.

23. The method of claim 19, further comprising:
compressing the treated operating fluid to aid in the dissolution of treatment fluid in the operating fluid.

24. The method of claim 23, wherein gravity assists with the compression of the treated operating fluid.

25. The method of claim 19, wherein mixing the treatment fluid with the operating fluid at least partially strips contamination from the operating fluid.

26. The method of claim 18, further comprising:
expelling the treatment fluid into an aquifer.

27. The method of claim 18, further comprising:
expelling the operating fluid into an aquifer.

28. The method of claim 27, further comprising:
exhausting undissolved treatment fluid so that the undissolved treatment fluid is not expelled into the aquifer.

29. The method of claim 28, further comprising:
removing at least a portion of contamination from the undissolved treatment fluid to create cleaned treatment fluid.

30. The method of claim 29, further comprising:
returning at least a portion of the cleaned treatment fluid to a source of treatment fluid.

31. The method of claim 18, wherein displacing the operating fluid creates a pressure differential between at least a portion of the path and a source of treatment fluid so that the treatment fluid is at least partially drawn into the operating path.

32. A method of installing a groundwater treatment system, comprising:
forming a borehole from a ground level to below a groundwater level;
installing a casing into the borehole, the casing including an inlet portion and an outlet portion separated by a seal mechanism, wherein the inlet portion is at least partially below the groundwater level;
installing a fluid displacement mechanism to displace groundwater from the inlet portion to the outlet portion by way of an operating path; and
installing a fluid interface configured to introduce a treatment fluid into the operating path so that the displaced groundwater carries the treatment fluid toward the outlet portion.
